(19) United States
(12) Patent Application Publication
(10) Pub. No.: US 2017/0210596 A1
(43) Pub. Date: Jul. 27, 2017

(54) CHARGE ALGORITHM FOR BATTERY PROPELLED ELEVATOR

(71) Applicant: Otis Elevator Company, Farmington, CT (US)

(72) Inventors: Carlo Mezzadri, Milano (IT); Carlo Colombari, Sala Bolognese (IT); Gianluca Foschini, Ravenna (IT)

(21) Appl. No.: 15/114,265

(22) PCT Filed: Jan. 27, 2014
(86) PCT No.: PCT/US2014/013140

§ 371 Date: Jul. 26, 2016

(51) Int. Cl. B66B 1/30; H02J 7/04; H02J 7/00

(52) U.S. Cl. CPC B66B 1/302; H02J 7/0021; H02J 7/04

(57) ABSTRACT

Embodiments are directed to recovering energy associated with the operation of an elevator, by: determining, by a processing device, a battery charging current, estimating a state of charge (SoC) of at least one battery based on charging current acceptance capability, and causing, by the processing device, a charging of the at least one battery to within a threshold amount of 100% of SoC to recover energy associated with elevator operation.

### BACKGROUND

In a given elevator system or environment, one or more sources may be used to provide power. For example, FIG. 1A shows an architecture or circuit 100 for an elevator system. The architecture 100 may include a battery 102 serving as a source of power for a motor 104, such as a permanent-magnet synchronous motor (PMSM). An inverter 106, denoted by the boxed components in FIG. 1A, may be used to generate currents for the motor 104.

The battery 102 may be a lead acid battery. The battery 102 may be charged by a charger 108. In a typical environment or application, the battery 102 may be slightly overcharged to maintain it at 100% of state of charge (SoC), increasing the standby power demand and degrading the energy efficiency of the system 100 during standby

As the elevator operates, regenerative energy may be generated. Due to the battery 102 having been charged to (nearly) 100% SoC, a dynamic braking resistor (DBR) 110 and/or a dynamic braking transistor (DBT) 112 may be used to consume the regenerative energy. In this manner, most of the elevator energy is wasted, degrading the running energy efficiency. Performance is adversely affected by this configuration.

### BRIEF SUMMARY

An embodiment is directed to a method for recovering energy associated with the operation of an elevator, comprising: determining, by a processing device, a battery charging current, estimating a state of charge (SoC) of at least one battery based on charging current acceptance capability, and causing, by the processing device, a charging of the at least one battery to within a threshold amount of 100% of SoC to recover energy associated with elevator operation.

An embodiment is directed to an apparatus comprising: at least one processor, and memory having instructions stored thereon that, when executed, cause the apparatus to: determine that it has been greater than a first threshold amount of time since an elevator was last run, cause a charger to be turned on to charge a battery of the elevator, setting a charging voltage according to at least one of battery temperature and ambient temperature, determine that it has been greater than a second threshold amount of time since the elevator was last run and application of the charging voltage, determine that a current associated with the charger is greater than a first threshold current based on one or more battery characteristics, and cause the charger to be maintained turned on to charge the battery.

An embodiment is directed to a method comprising: determining that an elevator has not been operated for an amount of time greater than a first threshold, determining a temperature associated with a battery of the elevator based on applying a testing charging voltage to the battery via a charger, wherein a value of the charging voltage is based on the temperature, determining that it has been greater than a second threshold amount of time since the elevator was last run and application of charging voltage, determining that a current associated with the charger is greater than a first threshold current and maintaining the testing voltage turned on as charging voltage, wherein a value of the charging voltage is based on the temperature, determining that the elevator has not been operated for an amount of time greater than the second threshold, determining that the current associated with the charger is less than a second threshold current, and removing the charging voltage from the battery.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1A illustrates a power architecture in accordance with the prior art;

FIG. 1B is a block diagram of components of an elevator system in an exemplary embodiment;

FIG. 2 illustrates a flow chart of an exemplary algorithm; and

FIG. 3 illustrates a flow chart of an exemplary method.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems and methods are described for accepting or delivering power or energy rapidly. In some embodiments, devices used to accept/deliver power or energy may act in a so-called peak shaving mode, enabling the devices to be as small as possible. Accordingly, device cost may be minimized. In some other embodiments of apparatuses, the component (e.g. ultra-capacitors) able to accept or deliver energy rapidly is directly connected with drive DC-link, accordingly device cost may be minimized due to the electrical topology itself.

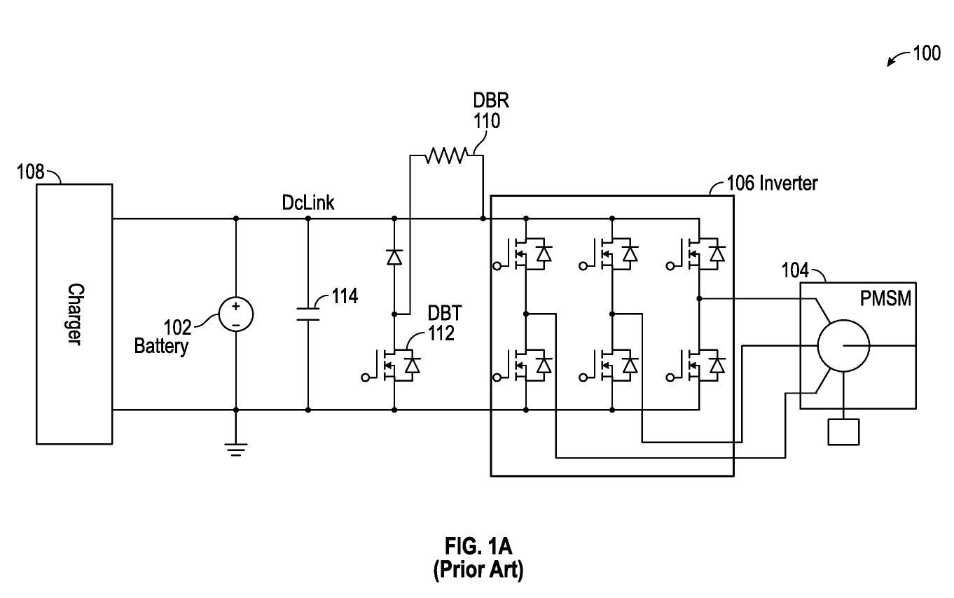

FIG. 1B is a block diagram of components of an elevator system 10 in an exemplary embodiment. The various entities shown in FIG. 1B may be arranged in any order or sequence, and the system 10 is merely one example of such an arrangement. For example, while the arrangement of FIG. 1B shows a battery charger 16 and battery 18 effectively in series with an AC power source 12, in some embodiments the battery charger 16 and/or the battery 18 may lie in parallel with the AC power source 12.

Elevator system 10 includes the source of AC power 12, such as an electrical main line. The AC power 12 is provided to a controller 14, which may include circuit breakers, meters, controllers, etc. From the controller 14, AC power is provided to the battery charger 16, which may convert the AC power to DC power to charge the battery 18. Battery 18 may be a lead-acid battery or other type of battery or combination of different types of batteries and ultra-capacitors. Battery 18 may power a drive unit 20. Drive unit 20 may include a control circuit board and a power circuit board. The power circuit board may convert DC power from battery 18 to AC drive signals, which drive a machine 22. The AC drive signals may be multiphase (e.g., three-phase) drive signals for a three-phase motor in machine 22.

The charger 16 may include one or more processors 34, and memory 36 having instructions stored thereon that, when executed, cause the charger 16 or the system 10 to perform one or more methodological acts as described herein. In some embodiments, the processors 34 and/or memory 36 may be located in another entity, such as a controller (e.g., controller 14).

In some embodiments, the charger 16 may provide for a buffer with respect to a state of charge (SoC) on the battery 18, such that the battery can accept charge resulting from operation of the elevator (e.g., regenerative energy). In other words, and as described further below, the charger 16 may ensure that at various points in time the battery 18 is charged to a level or value that is less than 100% SoC, such that the battery 18 can subsequently accept additional charge based on the operation of the elevator. In some embodiments, SoC detection may be performed by one or more other entities, such as a logic board or drive.

As part of one or more charging algorithms, potentially executed by the controller 14 or the charger 16, SoC may be determined or measured during periods when the elevator is idle or not in use in order to avoid the impact from fluctuations that are characteristic of operating the elevator. In some instances, the battery 18 may stabilize before an accurate reading is obtained.

In some embodiments, the controller 14 may cause the battery 18 to be charged to (approximately) 100% SoC periodically (e.g. monthly). Such charging may be used to help maintain battery state of health in terms of nominal capacity over long periods of time (e.g., years), avoiding a typical memory-effect of lead acid batteries. The battery 18 may be charged to approximately 100% SoC in order to prolong battery life

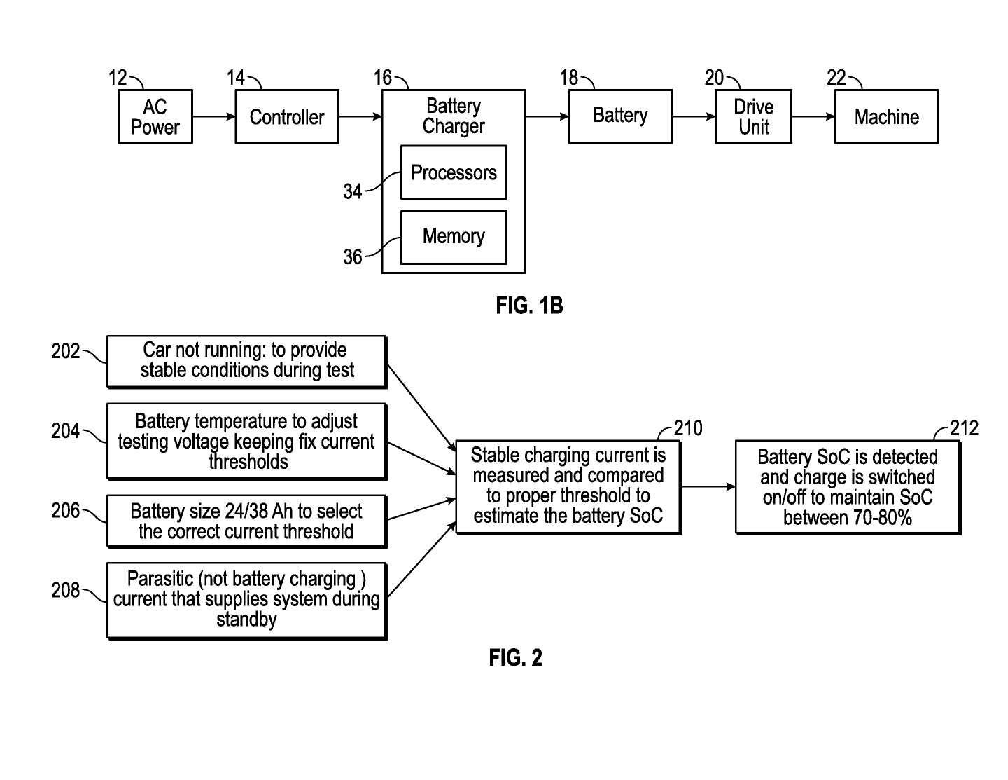

Turning now to FIG. 2, a flow chart of an exemplary algorithm 200 is shown. The algorithm 200 may be used to provide for intelligent or smart charging of a battery (e.g., battery 18) with SoC detection.

Blocks 202-208 may correspond to inputs to the algorithm 200. For example, block 202 may correspond to a condition or confirmation that an elevator car is not running. Such a condition/confirmation may be used to ensure stable conditions during a SoC test, and may be used to achieve a reliable SoC estimation of a battery that is loaded by an intermittent load, typical of an elevator application.

Block 204 may correspond to a determination of a temperature of a battery. Knowledge of the battery temperature may be used to adjust a testing and charging voltage while keeping or maintaining current thresholds insensitive to battery temperature and at the same time improving battery life and performance, both affected by battery cell temperature.

Block 206 may correspond to a determination of a battery size (e.g., 24/38 Amp hours (Ah)). Knowledge of the battery size and characteristics may be used to select one or more appropriate current thresholds.

Block 208 may correspond to a determination of the parasitic current that can affect the reliability of the SoC detection with a close circuit configuration. The parasitic current may supply the system 100 during standby. The parasitic current may be subtracted from a measured current during SoC testing to improve estimation accuracy.

Based on the determination of the charging current in block 210, the battery SoC may be estimated by comparing measured current and proper thresholds. Switching on or off the battery charge, SoC may be set at 70-80% as provided in block 212. Operating at a SoC that is less than 100% may provide for greater charging efficiency relative to operating at 100% SoC.

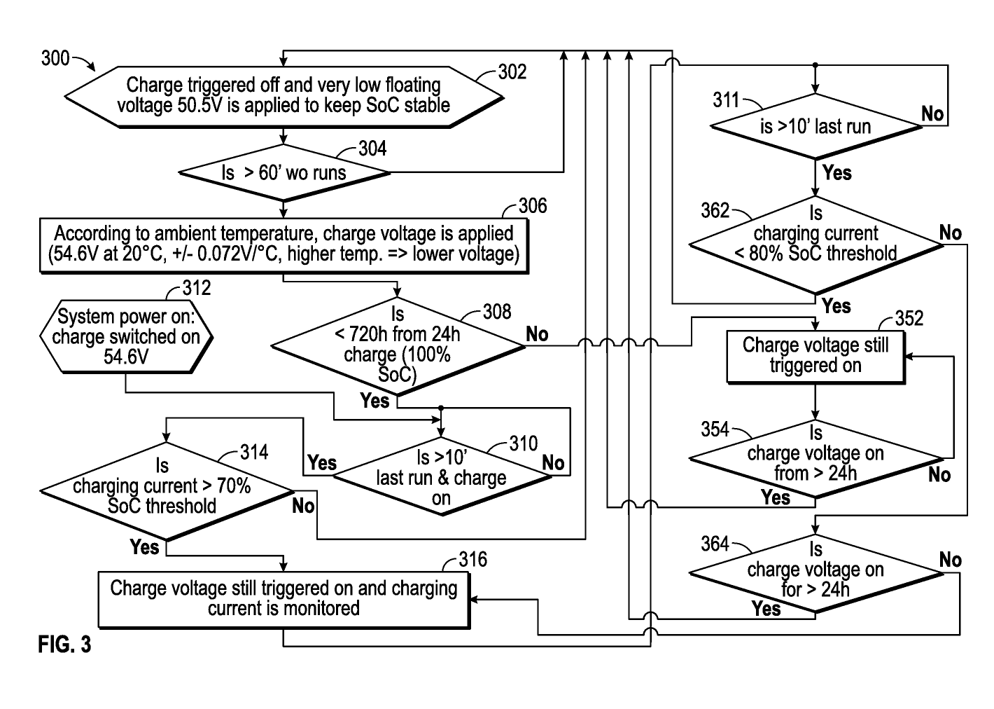

Turning now to FIG. 3, a flow chart of an exemplary method 300 is shown. The method 300 may be used to provide for intelligent or smart charging of a battery (e.g., battery 18) with SoC detection. In some embodiments, one or more aspects of the algorithm 200 of FIG. 2 may be incorporated into the method 300 of FIG. 3, or vice versa.

Block 302 may correspond to a starting point/operation for the method 300. In block 302, battery charge may be off. A low floating voltage of, e.g., 50.5 Volts (2.10V per cell) may be associated with a battery (e.g., battery 18) to maintain the SoC around 70-80% during standby phase. From block 302, flow may proceed to block 304.

In block 304, a determination may be made whether the time since the last elevator run is greater than a threshold (e.g., 60 minutes). If so (e.g., the “yes” path is taken out of block 304), flow may proceed from block 304 to block 306. Otherwise (e.g., the “no” path is taken out of block 304), flow may proceed from block 304 to block 302. The determination of block 304 may be used to ensure stability with respect to the SoC test that is performed as part of the method 300. A sufficient relaxation time may be used to stabilize battery chemistry of the battery, like lead acid.

In block 306, a charging voltage may be applied by the charger (e.g., charger 16) to a battery (e.g., battery 18 of FIG. 1B). The charging voltage may be a function of temperature, which may correspond to ambient temperature and/or the temperature of the battery. For example, at 20° C., the charging voltage may be applied at 54.6 Volts. An adjustment of plus-or-minus 0.072 Volts/° C. may be made, where a higher temperature leads to a lower applied voltage. From block 306, flow may proceed to block 308.

In block 308, a determination may be made whether it has been less than some amount of time (e.g., approximately 720 hours or 30 days) from a so-called “complete charge cycle” where the battery is fully charged to (approximately) 100% SoC. If so (e.g., the “yes” path is taken out of block 308), flow may proceed from block 308 to block 310. Otherwise (e.g., the “no” path is taken out of block 308), flow may proceed from block 308 to block 352.

In conjunction with the flow from block 308 to block 310, system power may be turned on (block 312). In block 310, a determination may be made whether it has been greater than some amount of time (e.g., 10 minutes) since the last run and application of charging voltage (306). If so (e.g., the “yes” path is taken out of block 310), flow may proceed from block 310 to block 314. Otherwise (e.g., the “no” path is taken out of block 310), flow may remain at block 310.

In block 314, a determination may be made whether the current output from the charger is greater than a threshold, where the threshold may correspond to, e.g., 70% SoC. If so (e.g., the “yes” path is taken out of block 314), flow may proceed from block 314 to block 316. Otherwise (e.g., the “no” path is taken out of block 314), flow may proceed from block 314 to block 302.

In block 316, the recharge remains switched on. As part of block 316, a monitoring (e.g., continuous monitoring) of the charge current may be provided. From block 316, flow may proceed to block 311.

In block 311, a determination may be made whether it has been greater than some amount of time (e.g., 10 minutes) since the last run. If so (e.g., the “yes” path is taken out of block 311), flow may proceed from block 311 to block 362. Otherwise (e.g., the “no” path is taken out of block 311), flow may remain at block 311. The determination of block 311 may be performed in order to provide a sufficient relaxation time before reading charging current.

In block 362 a determination may be made whether the charge current is less than a threshold, where the threshold may correspond to, e.g., 80% SoC. If so (e.g., the “yes” path is taken out of block 362), flow may proceed from block 362 to block 302. Otherwise (e.g., the “no” path is taken out of block 362), flow may proceed from block 362 to block 364. The determination of block 362 may used to verify that the battery is charged enough to trigger the charge off.

In block 364, a determination may be made whether the charger has been on for a period of time greater than a threshold (e.g., approximately 24 hours or 1 day). The threshold may be selected to satisfy one or more safety requirements or parameters. In some embodiments, the threshold may be specified as a current associated with a charge of approximately 95% or 100%. If the determination of block 364 is answered in the affirmative (e.g., the “yes” path is taken out of block 364), flow may proceed from block 364 to block 302. Otherwise (e.g., the “no” path is taken out of block 364), flow may proceed from block 364 to block 316.

In block 352, the charger voltage may be remain on. Flow may proceed from block 352 to block 354.

In block 354, a determination may be made whether the charger has been on for a period of time greater than a threshold (e.g., 24 hours or 1 day). If so (e.g., the “yes” path is taken out of block 354), flow may proceed from block 354 to block 302. Otherwise (e.g., the “no” path is taken out of block 354), flow may proceed from block 354 to block 352. The determination of block 354 may be used to avoid any memory-effect as described above.

The values described above in connection with FIGS. 2 and 3 are merely illustrative. One skilled in the art would appreciate that the values used may be modified without departing from the scope and spirit of this disclosure. Moreover, the blocks or operations may execute in an order or sequence different from what is shown in FIGS. 2 and 3. In some embodiments, one or more of the blocks (or a portion thereof) may be optional. In some embodiments, additional blocks or operations not shown may be included.

In some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory having instructions stored thereon that, when executed by the one or more processors, cause the apparatus or system to perform one or more methodological acts as described herein. In some embodiments, one or more input/output (I/O) interfaces may be coupled to one or more processors and may be used to provide a user with an interface to an elevator system. Various mechanical components known to those of skill in the art may be used in some embodiments.

Embodiments may be implemented as one or more apparatuses, systems, and/or methods. In some embodiments, instructions may be stored on one or more computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method for recovering energy associated with the operation of an elevator, comprising:
determining, by a processing device, a battery charging current;
estimating a state of charge (SoC) of at least one battery based on charging current acceptance capability; and
causing, by the processing device, a charging of the at least one battery to within a threshold amount of 100% of SoC to recover energy associated with elevator operation.

2. The method of claim 1, wherein the battery is charged under 100% of SoC.

3. The method of claim 1, wherein the threshold corresponds to a value in the range of 60% to 95% percent of the full SoC.

4. The method of claim 1, wherein the determination of the charging current and the SoC is done after a relaxation time detecting when the elevator car is running and waiting a proper time based on the load stress applied to battery.

5. The method of claim 1, wherein the temperature associated with the at least one battery is detected to adjust testing and charge voltage to maintain stable charging current thresholds to estimate SoC and to extend battery life.

6. The method of claim 1, wherein the size and characteristics of the at least one battery are used to select the charging current thresholds to estimate SoC.

7. The method of claim 1, wherein a parasitic current is estimated and considered to avoid impacting the determination of the charging current.

8. The method of claim 1, wherein the at least one battery comprises a lead acid battery.

9. The method of claim 1, further comprising:
subsequent to charging the at least one battery to within the threshold amount of 100% SoC, determining, by the processing device, that the at least one battery has not been fully charged for an amount of time greater than a second threshold; and
causing, by the processing device, the at least one battery to be charged for an amount of time greater than a third threshold based on determining that the at least one battery has not been fully charged for the amount of time greater than the second threshold.

10. The method of claim 9, wherein the second threshold is approximately 30 days, and wherein the third threshold is approximately 1 day.

11. The method of claim 1, further comprising:
causing the elevator to operate; and
charging the at least one battery based on energy generated by the operation of the elevator.

12. An apparatus comprising:
at least one processor; and
memory having instructions stored thereon that, when executed, cause the apparatus to:
determine that it has been greater than a first threshold amount of time since an elevator was last run;
cause a charger to be turned on to charge a battery of the elevator;
setting a charging voltage according to at least one of battery temperature and ambient temperature;
determine that it has been greater than a second threshold amount of time since the elevator was last run and application of the charging voltage;
determine that a current associated with the charger is greater than a first threshold current based on one or more battery characteristics; and
cause the charger to be maintained turned on to charge the battery.

13. The apparatus of claim 12, wherein the instructions, when executed, cause the apparatus to:
determine whether the charging current is less than a second threshold current subsequent to causing the charger to be turned off;

14. The apparatus of claim 13, wherein the first threshold current corresponds to approximately 60% of full state of charge (SoC), and wherein the second threshold current corresponds to approximately 95% of full SoC.

15. The apparatus of claim 13, wherein the instructions, when executed, cause the apparatus to:
determine whether the charger has been turned on for a period of time greater than a third threshold amount of time based on determining that the current associated with the charger is not less than the second threshold current; and
cause the charger to be turned off based on determining that the charger has been turned on for the period of time greater than the third threshold amount of time.

16. The apparatus of claim 15, wherein the third threshold amount of time is approximately 1 day.

17. The apparatus of claim 12, wherein the instructions, when executed, cause the apparatus to:
periodically turn on the charger so as to cause the battery to be charged to a full state of charge (SoC).

18. The apparatus of claim 12, wherein the instructions, when executed, cause the apparatus to:
subsequent to charging the battery to within a threshold amount of 100% state of charge (SoC), determine that the at least one battery has not been fully charged based on a measured current; and
cause the battery to be charged until the measured current is within a threshold corresponding to the threshold amount of 100% SoC.

19. A method comprising:
determining that an elevator has not been operated for an amount of time greater than a first threshold;
determining a temperature associated with a battery of the elevator based on applying a testing charging voltage to the battery via a charger, wherein a value of the charging voltage is based on the temperature;
determining that it has been greater than a second threshold amount of time since the elevator was last run and application of charging voltage;
determining that a current associated with the charger is greater than a first threshold current and maintaining the testing voltage turned on as charging voltage, wherein a value of the charging voltage is based on the temperature;
determining that the elevator has not been operated for an amount of time greater than the second threshold;
determining that the current associated with the charger is less than a second threshold current; and
removing the charging voltage from the battery.

20. The method of claim 19, wherein the first threshold current corresponds to approximately the current that the battery accepts when in a 70% full state of charge (SoC) condition, and wherein the second threshold current corresponds to approximately the current that the battery accepts when in an 80% full SoC condition.
